(19) United States
(12) Patent Application Publication
(10) Pub. No.: US 2012/0196983 A1
(43) Pub. Date: Aug. 2, 2012

(54) METHOD OF PRODUCING THERMOPLASTIC RESIN COMPOSITION AND THERMOPLASTIC RESIN COMPOSTION

(75) Inventors: Naoyuki ONO, Tokyo (JP); Hiroaki KASAI, Tokyo (JP); Naohito SHIGA, Tokyo (JP)

(73) Assignee: Olympus Corporation, Tokyo (JP)

(21) Appl. No.: 13/360,982

(22) Filed: Jan. 30, 2012

(30) Foreign Application Priority Data
Jan. 31, 2011 (JP) 2011-018937

(51) Int. Cl. C08L 27/18; C08L 61/00; C08L 25/02; C08L 81/04; C08L 77/00; C08L 81/06; C08L 79/08

(52) U.S. Cl. 525/189; 525/185; 525/190

(57) ABSTRACT

A thermoplastic resin composition and a method of producing the thermoplastic resin composition are provided. The thermoplastic resin composition has an excellent balance of flexibility, heat resistance, and abrasion resistance, and has an excellent moldability. The method includes the steps of heating in which a heat-processed product is heated at a maximum heating temperature of 327° C. or higher, the heat-processed product being obtained by heat-processing a mixture containing the thermoplastic resin and the PTFE particles; and cooling in which the heat-processed product is cooled at a cooling speed of 10° C./min or slower to 293° C. from the maximum heating temperature after the step of heating.

### BACKGROUND OF THE INVENTION

1. Field of the Invention

The present invention relates to a method of producing a thermoplastic resin composition and a thermoplastic resin composition. Particularly, the present invention relates to a thermoplastic resin composition, which has excellent heat and abrasion resistances, in addition to an excellent moldability, and a shaped product made of the thermoplastic resin composition.

Priority is claimed on Japanese Patent Application No. 2011-018937, filed Jan. 31, 2011, the content of which is incorporated herein by reference.

2. Description of Related Art

Polytetrafluoroethylene (PTFE) is a thermoplastic resin having excellent properties in heat resistance, chemical resistance, high slidability, low abrasion property, and chemical stability. PTFE has been utilized in a wide varieties of fields, such as the medical field, the electronic/electronic device field, the machine parts field, the auto parts field, and the OA equipment parts field.

Although PTFE has the excellent properties described above, it has a shortcoming of a poor moldability.

When a standard heat-processing method, in which the thermoplastic resin is heated, is applied in a shape forming of PTFE, PTFE is decomposed without being molten.

To solve the above-mentioned problem, alternative thermoplastic resin compositions, such as thermoplastic fluororesin, have been developed.

For example, a copolymer composition for melt molding is disclosed in Japanese Unexamined Patent Application, First Publication No. 2003-327770. In the copolymer composition, PTFE particles are blended to perfluoro (alkylvinylether), and a mechanical property and moldability are improved.

Also, compositions, which have a higher thermal stability compared to PTFE and is as slidable as PTFE, are disclosed in Japanese Unexamined Patent Application, First Publication No. H5-17652, Japanese Unexamined Patent Application, First Publication No. H8-157678, and Japanese Unexamined Patent Application, First Publication No. H10-316842. In the compositions, PTFE particles are blended to a thermoplastic resin with a higher melting point than that of PTFE.

### SUMMARY OF THE INVENTION

An aspect of the present invention is a method of producing a thermoplastic resin composition (hereinafter referred as “the method of producing a thermoplastic resin composition of the present invention” or “the thermoplastic resin composition producing method of the present invention”) including a thermoplastic resin, a storage elastic modulus of which at 330° C. is 10 MPa or higher, and PTFE particles, which are added to the thermoplastic resin, comprising the steps of heating in which a heat-processed product is heated at a maximum heating temperature of 327° C. or higher, the heat-processed product being obtained by heat-processing a mixture containing the thermoplastic resin and the PTFE particles; and cooling in which the heat-processed product is cooled at a cooling speed of 10° C./min or slower to 293° C. from the maximum heating temperature after the step of heating.

In the method of producing a thermoplastic resin composition of the present invention, an elapsed time, which the heat-processed product is held in a temperature range of 293 to 297° C., may be 5 minutes or longer.

The method of producing a thermoplastic resin composition of the present invention may further comprises the step of heat-processing, in which the mixture is molded in a mold to obtain the heat-processed product, before the step of heating, wherein the heat-processed product in the steps of heating and cooling may be kept in the mold without taking out from the mold.

Another aspect of the present invention is a thermoplastic resin composition (hereinafter referred as “the thermoplastic resin composition of the present invention”) comprising: a thermoplastic resin, a storage elastic modules of which at 330° C. is 10 MPa or higher; and PTFE particles, wherein a crystallinity of PTFE particles is 55 or higher.

In the thermoplastic resin compound of the present invention, 20 to 900 parts of PTFE particles by weight may be included in 100 parts of the thermoplastic resin with a storage elastic modulus of 10 MPa or higher at 330° C. by weight.

Also, an average diameter of the PTFE particles may be 200 μm or less.

### BRIEF DESCRIPTION OF THE DRAWINGS

FIG. 1. is a flowchart for explaining the method of producing a thermoplastic resin composition of the present invention.

### DETAILED DESCRIPTION OF THE INVENTION

### Embodiments of the Invention

Embodiments of the method of producing a thermoplastic resin composition and the thermoplastic resin composition of the present invention are explained below.

First, materials for the thermoplastic resin composition of the present embodiment are explained.

The thermoplastic resin composition of the present embodiment includes a thermoplastic resin, a storage elastic modules of which at 330° C. is 10 MPa or higher; and PTFE particles made of polytetrafluoroethylene (PTFE).

The thermoplastic resin can be one or more selected from the group consisting of poly ether sulfone (PES), polyamide (PA), poly sulfone (PSU), polyetheretherketone (PEEK), poly phenylene sulfide (PPS), polyamide imide (PAI), poly ether imide (PEI), polyimide (PI), and polyarylate (PAR).

PTFE particles with a suitable diameter can be selected and mixed to the thermoplastic resin to satisfy a specific purpose. For example, the PTFE particles used in the present embodiment have an average diameter of 200 μm or lower. The diameter of the PTFE particles can be measured by a dry laser measurement method. In addition, a crystallinity of the PTFE particles in the thermoplastic resin is 55 or higher.

PTFE particles with various diameters can be combined to mix to the thermoplastic resin.

Next, the method of producing a thermoplastic resin composition of the present embodiment is explained.

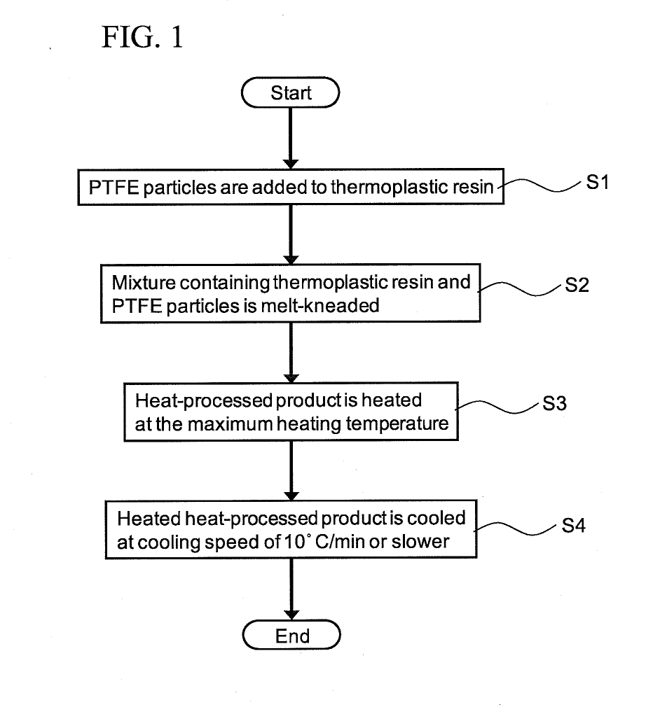

FIG. 1. is a flowchart for explaining the method of producing a thermoplastic resin composition.

First, the above-mentioned thermoplastic resin and the PTFE particles are mixed (mixing step S1).

In the mixing step S1, 20 to 900 parts of PTFE particles by weight are added to 100 parts of the thermoplastic resin by weight.

Next, the mixture of the thermoplastic resin and the PTFE particles are melt-kneaded (heat-process) (melt-kneading (heat-processing) step S2).

There is no particular limitation for an apparatus used in the melt-kneading in the melt-kneading step S2. Therefore, known kneading machines or the like, such as a single screw extruder, a twin screw extruder, a roll, a banbury mixer, varieties of kneaders, and the like, can be used. For example, the mixture (heat-processed product) that has been kneaded already can be ejected continuously during kneading the thermoplastic resin and the PTFE particles, by using a twin screw extruder with an appropriate L/D value, a pressing kneader, or the like.

The melt-kneading step S2 is finished when the thermoplastic resin and the PTFE particles are kneaded completely.

The melt-kneaded mixture (heat-processed product) can be shaped into a pre-determined shape by filling into a mold, extrusion molding, or the like.

Next, the melt-kneaded mixture (heat-processed product) is heated at the maximum heating temperature (heating step S3).

In the heating step S3, the heat-processed product is placed in a heating furnace. The temperature of the atmosphere in the heating furnace is set to 330° C. (the maximum heating temperature in the present embodiment). The temperature in the heating furnace is not limited to be 330° C. The temperature can be higher than 330° C., as long as the storage elastic modulus of the thermoplastic resin is 10 MPa or higher at the temperature.

The heat-processed product placed in the heating furnace is heated at a temperature higher than 327° C., which is the melting temperature of the PTFE particles included in the heat-processed product. With this treatment, the PTFE particles in the heat-processed product are melted. The shape of the heat-processed product is retained, since the storage elastic modulus of the thermoplastic resin at 330° C. is 10 MPa or higher.

When the thermoplastic resin composition is placed in the atmospheric temperature at 330° C., the temperature at the outer surface of the heat-processed product is increased due to heat exchange to the surrounding atmosphere. Then, the internal temperature of the heat-processed product is increased. Therefore, there is a temperature gradient of several Celsius degrees between the surface and the internal part of the heat-processed product.

The temperatures at the surface and the internal part of the heat-processed product can be set evenly at 327° C. by keeping the atmospheric temperature in the heating furnace at 327° C. However, it takes long period of time for the temperature to reach to 327° C. over the all of the internal part of the heat-processed product. By setting the atmospheric temperature in the heating furnace at a temperature higher than 327° C., the temperature at the all internal part of the heat-processed product can be raised to 327° C. in a short period of time, improving productivity of the composition.

When the heating temperature in the heating furnace is lower than 327° C., the crystallinity of the PTFE particles, which is obtained in the melt-kneading step and the molding process by cooling the heat-process product, is kept. Therefore, it becomes difficult to improve the crystallinity of the heat-processed product afterward.

Next, the heated heat-processed product is cooled at the cooling speed of 10° C./min or slower (cooling step S4).

In the cooling step S4, the PTFE particles, which are heated at the melting point of PTFE or higher, are crystallized by cooling them at the cooling speed of 10° C./min or slower. The crystallization of PTFE progresses in the cooling in the temperature range of 327° C., which is the melting temperature of PTFE, to 293° C. Particularly, the crystallization progresses well in the temperature range of 297° C. to 293° C. Progress of crystallization under temperatures below 293° C. is less (slow). The crystallinity of the PTFE depends on the cooling speed of the heat-processed product. In particular, the crystallinity of the PTFE is determined by the cooling speed from 327° C., which is the melting temperature of PTFE, to 293° C.

The slower the cooling speed of the heat-processed product, the higher the crystallinity of PTFE. When the cooling speed is faster than 10° C./min, it becomes impossible to increase the crystallinity of the PTFE particles in the thermoplastic resin. As a result, abrasion resistance of the produced composition is reduced.

The crystallinity of PTFE can be further improved by holding the heat-processed product for a pre-determined period of time within the temperature range of 297 to 293° C. Crystallization of PTFE advances particularly well in the temperature range. For example, crystallization of PTFE in the heat-processed product can be progressed, and the PTFE can be crystallized evenly by holding the heat-processed product for 5 minutes in a condition where the atmospheric temperature ranged from 293 to 297° C. in the heating furnace. The period of time that the heat-processed product is held in the atmospheric temperature ranged from 293 to 297° C. in the heating furnace can be longer than 5 minutes.

The abrasion resistance of PTFE is significantly affected by the crystallinity of PTFE. In other words, the higher the crystallinity of PTFE, the better the abrasion resistance. In the present embodiment, the crystallization of the heated heat-processed product is progressed in the temperature range of 297 to 293° C. As a result, the crystallinity of the PTFE particles in the heat-processed product becomes 55 or higher. The crystallinity of PTFE used in the PTFE particles can be determined by measuring the density of the PTFE. The average density of PTFE is 2.17 in general. However, the density of PTFE deviates about 10% or less, depending on the level of its crystallinity. For example, the density of PTFE is 2.08, when its crystallinity is 55. To measure the density of PTFE, standard methods can be used. For example, the density can be calculated from a result obtained from a density measurement and a blending ratio of the kneaded materials. Alternatively, the density of PTFE can be measured directly after removing the resin component by liquefying the resin component.

Both the thermoplastic resin and the PTFE particles are materials with a carbon skeleton. Therefore, they have a similar amount of thermal contraction. However, there is an extra contraction for the PTFE particles, since they are crystallized when the heat-processed product is cooled in the step of cooling. Difference of densities of PTFE is mainly caused by the volume change due to the thermal contraction associated with the crystallization. The diameter of the PTFE particle is reduced 5% or less compared to a state where the PTFE particle is not crystallized by the volume change of the PTFE particles.

When the PTFE particles are thermal contracted, small clearances are formed between the PTFE particles and the thermoplastic resin. It is difficult for the PTFE particles to be dislodged from the thermoplastic resin when the dimension of the clearance is 10 μm or less. In addition, the thermal contraction of the PTFE particles is hardly inhibited by the surrounding thermoplastic resin, when the extent of the reduction of the diameter of the PTFE is small enough. In the present embodiment, the average diameter of the PTFE particles is 200 μm or less. Therefore, the dimension of the clearance is 10 μm or less even if the diameter of the PTFE particle is reduced 5% or less due to its crystallization. As a result, the PTFE is crystallized sufficiently, and the abrasion resistance of the thermoplastic resin composition is improved.

After the temperature of the heat-processed product is dropped to 293° C. or less, there is no need to control the cooling speed at 10° C./min or slower. Thus, the heat-treated product can be taken out from the heating furnace for cooling.

As explained above, in the method of producing a thermoplastic resin composition of the present embodiment, the temperature of the heat-processed product is increased to the melting temperature of PTFE particles or higher in the heating step S3, and B the heated heat-processed product is cooled at the cooling speed of 10° C./min or slower in the cooling step S4. Therefore, crystallization of the PTFE particles can be progressed, and the crystallinity of the PTFE particles can be increased sufficiently. As a result, the thermoplastic resin composition, which has an excellent balance of flexibility, heat resistance, and abrasion resistance, and has a excellent moldability, can be produced.

In addition, by holding the heat-processed product for 5 minute or longer within the temperature range of 293 to 297° C. in the cooling step S4, the crystallinity of the PTFE particles in the resin composition can be further increased. Also, each of the PTFE particles can be crystallized evenly. As a result, heat resistance and abrasion resistance of the PTFE particles themselves can be further improved.

### Modified Example

Next, a modified example of the above-mentioned embodiment is explained.

The present modified example is different from the above-mentioned embodiment in performing the steps of heating S3 and cooling S4 in a state where the heat-processed product at the end of the melt-kneading step S2 is kept in the mold without taking out from the mold.

The mold used in the present modified example is configured to allow heating and cooling of the heat-processed product filled in the mold in a regulated manner.

In the present modified example, the mold and the heat-processed product are directly contacted, allowing direct heat exchange between them in the steps of heating S3 and cooling S4. Since thermal conductivity of the mold made of a metal is higher than that of air, the temperature control of the heat-processed product can be regulated at a high precision compared to the case where the temperature of the heat-processed product is regulated by controlling the atmospheric temperature in the heating furnace in the present modified example. In addition, each of the PTFE particles can be evenly crystallized with a high crystallinity over the all of the internal part of the heat-processed product. As a result, a shaped product made of the thermoplastic resin composition, which has excellent heat resistance, abrasion resistance, and moldability, can be produced from the heat-processed product made of the thermoplastic resin and the PTFE particles.

Next, the thermoplastic resin composition of the present invention is explained in detail using each example and comparative example below.

TABLE 1 summarizes the examples of the thermoplastic resin composition of the present invention. TABLE 2 summarizes the comparative examples. The thermal conditions shown in TABLES 1 and 2 indicate, the maximum heating temperature, which was the heat-processed product was exposed, and the cooling speed controlling temperature, which was the temperature the maximum heating temperature was dropped to at the indicated cooling speed. Also, in cases where they were needed, the holding time and the holding temperature are indicated in TABLES 1 and 2. They show that the heat-processed product were held at the holding temperature for the holding time in the cooling step. The symbol “-” shown in the holding temperature and the holding time rows indicate that there was no holding treatment in the example.

TABLE 1

| | | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Composition | PES 4800G | 100 | | | 100 | 100 | 100 | 100 | 100 | 100 | 100 | 100 | 100 | 100 |
| | PSU P-3500 | | 100 | | | | | | | | | | | |
| | PPSU R-5000 | | | 100 | | | | | | | | | | |
| | PTFE M-18 | 300 | 300 | 300 | 300 | 300 | 300 | 300 | 300 | 20 | 900 | | 10 | 1000 |
| | PTFE M-139 | | | | | | | | | | | 300 | | |
| Thermal condition | Maximum heating | 330 | 330 | 330 | 330 | 330 | 330 | 330 | 330 | 330 | 330 | 330 | 330 | 330 |
| | temperature (° C.) | | | | | | | | | | | | | |
| | Cooling speed (° C./min) | 4 | 4 | 4 | 4 | 4 | 4 | 4 | 4 | 4 | 4 | 4 | 4 | 4 |
| | Cooling speed controlling | 290 | 290 | 290 | 290 | 290 | 290 | 290 | 290 | 290 | 290 | 290 | 290 | 290 |
| | temperature (° C.) | | | | | | | | | | | | | |
| | Holding temperature (° C.) | — | — | — | 295 | 290 | 300 | 295 | — | — | — | — | — | — |
| | Holding time (min) | — | — | — | 5 | 5 | 5 | 3 | — | — | — | — | — | — |
| | Thermal treatment in the mold | No | No | No | No | No | No | No | Yes | No | No | No | No | No |
| PTFE particle | Crystallinity of PTFE | 57 | 57 | 57 | 66 | 61 | 62 | 62 | 57 | 57 | 57 | 55 | 57 | 57 |
| Test result | (1) Hardness (Type D) | 55 | 57 | 58 | 55 | 55 | 55 | 56 | 57 | 84 | 42 | 53 | 95 | 40 |
| | (2) Heat deflection | 160 | 143 | 163 | 172 | 160 | 161 | 164 | 166 | 207 | 151 | 157 | 200 | 144 |
| | temperature (° C.) | | | | | | | | | | | | | |
| | (3) Abrasion amount (mg) | 94 | 71 | 98 | 83 | 94 | 95 | 90 | 88 | 74 | 118 | 115 | 65 | 230 |
| | (4) Moldability | Fair | Fair | Fair | Fair | Fair | Fair | Fair | Fair | Good | Fair | Fair | Good | Not good |
| | (5) Shape retention | Fair | Fair | Fair | Good | Fair | Fair | Fair | Good | Good | Fair | Fair | Good | Fair |

TABLE 2

| | | Comparative | Comparative | Comparative | Comparative | Comparative |
|---|---|---|---|---|---|---|
| | | Ex. 1 | Ex. 2 | Ex. 3 | Ex. 4 | Ex. 5 |
| Composition | PES 4800G | | | 100 | 100 | 100 |
| | PFA AP-210 | 100 | | | | |
| | FEP NP-20 | | 100 | | | |
| | PTFE M-18 | 300 | 300 | 300 | 300 | 300 |
| Thermal condition | Maximum heating | 330 | 330 | 320 | 330 | 330 |
| | temperature (° C.) | | | | | |
| | Cooling speed (° C./min) | 4 | 4 | 4 | 15 | 4 |
| | Cooling speed controlling | 290 | 290 | 290 | 290 | 300 |
| | temperature (° C.) | | | | | |
| | Holding temperature (° C.) | — | — | — | — | — |
| | Holding time (min) | — | — | — | — | — |
| | Thermal treatment in the mold | No | No | No | No | No |
| PTFE particle | Crystallinity of PTFE | 56 | 56 | 42 | 43 | 53 |
| Test result | (1) Hardness (Type D) | 44 | 42 | 53 | 51 | 53 |
| | (2) Heat deflection | 51 | 40 | 90 | 93 | 120 |
| | temperature (° C.) | | | | | |
| | (3) Abrasion amount (mg) | 103 | 126 | 315 | 330 | 270 |
| | (4) Moldability | Fair | Fair | Fair | Fair | Fair |
| | (5) Shape retention | Not good | Not good | Fair | Fair | Fair |

Materials used for the Examples of the present invention and the comparative examples are shown below.

### (1) Thermoplastic Resin

PES: Sumika Excel PES (Polyethersulphone) 4800G (manufactured by Sumitomo Chemical Co., the storage modulus at 330° C.: 120 MPa, heat deflection temperature: 203° C. (1.8 MPa))

PSU: Udel P-3500 (manufactured by Solvay Advanced Polymers, in the storage modulus at 330: 60 MPa, heat deflection temperature: 174° C. (1.8 MPa))

PPSU: Radel R-5000 (manufactured by Solvay Advanced Polymers, in the storage modulus at 330: 85 MPa, heat deflection temperature: 207° C. (1.8 MPa))

PFA: Neoflon AP-210 (manufactured by Daikin Industries, Ltd., in the storage modulus at 330: 1.2 MPa, heat deflection temperature: 55° C. (1.8 MPa))

FEP: Neoflon NP-20 (manufactured by Daikin Industries, Ltd., in the storage modulus at 330: 0.7 MPa, heat deflection temperature: 47° C. (1.8 MPa))

### (2) PTFE Particle

Molding powder M-18 (manufactured by Daikin Industries, 40 μm average particle size).

Molding powder M-139 (manufactured by Daikin Industries, 400 μm average particle diameter).

Evaluation methods for the Examples of the present invention and the comparative examples are shown below.

### (1) Flexibility

Flexibility of thermoplastic resin compositions were measured by Type D durometer hardness based on the JIS (Japanese Industrial Standards) K 7215. Having a low hardness value indicates that the composition has an excellent flexibility. Testing pieces with a thickness of 6.3 mm were prepared by hot compression molding. The hot pressing was performed at 370° C. The testing pieces were heat treated as indicated in TABLES 1 and 2 after the hot pressing.

### (2) Heat Resistance

Heat resistance was evaluated by measuring the heat deflection temperature based on the JIS K 7191. The measuring load was 1.8 MPa. Having a high value in the heat deflection temperature indicates that the composition has an excellent heat resistance. Testing pieces, which had a dimension of 80×10 mm and a thickness of 4 mm, were prepared by hot pressing. The hot pressing was performed at 370° C. The testing pieces were heat treated as indicated in TABLES 1 and 2 after the hot pressing.

### (3) Abrasion Resistance

Abrasion resistance was evaluated by the amount of abrasion in a sliding abrasion test based on the JIS K 7218. Having a small amount of abrasion indicates the composition has an excellent abrasion resistance. Testing pieces, which had a dimension of 30×30 mm and a thickness of 1 mm, were prepared by hot pressing. The hot pressing was performed at 370° C. The testing pieces were heat treated as indicated in TABLES 1 and 2 after the hot pressing.

Engaging material: S45C ring (contacting area: 2 cm²)

Load: 100N

Speed: 0.5 m/s

Temperature: in an atmosphere at 150° C.

Test time: 60 minutes

### (4) Moldability

Strip testing pieces, which had a dimension of 80 mm×10 mm×4 mm, were injection-molded with a 80t injection machine. After the molding, the strip testing pieces were heat treated as indicated in TABLES 1 and 2. After the heat treatment, appearance of the strip testing pieces were inspected by a visual observation. In the inspection, existence or non-existence of the flow mark and occurrence of shrinkage were monitored. Moldability was ranked as indicated below.

Good: There was no flow mark and shrinkage.

Fair: A flow mark and shrinkage were observed under the pressure condition described above. However, the problem can be solved by increasing the injection and retention pressures in the injection-molding.

Not good: A flow mark and shrinkage appeared in any injection-molding condition tested.

### (5) Shape Retention

Strip testing pieces, which had a dimension of 80 mm×10 mm×4 mm, were injection-molded with a 80t injection machine. After the molding, the strip testing pieces were heat treated as indicated in TABLES 1 and 2. After the heat treatment, appearance of the strip testing pieces were inspected by a visual observation. In the inspection, deformation of the strip testing pieces after the heat treatment was monitored. Shape retention was ranked as indicated below.

Good: There was almost no shape difference between a strip testing piece before and after the heat treatment.

Fair: There was almost no shape difference between a strip testing piece before and after the heat treatment as a whole. However, edges of the strip testing piece after the heat treatment were slightly rounded.

Not good: There was a significant difference of shapes before and after the heat treatment.

### Example 1

First, PES 4800G and PTFE M-18 in the composition ratio (weight ratio) shown in TABLE 1 were fed to a twin screw extruder having a screw diameter of 20 mm in Example 1. Then, they were melt-kneaded in a condition where the temperature was 360° C. and the revolution was 60 rpm, turning them into pellets. Then, strip testing pieces were molded from the pellets. The molded pellets were heat treated in the thermal condition shown in TABLE 1. The heat treated strip testing pieces were subjected above-mentioned tests. Evaluation results were shown in TABLE 1.

As clearly shown in TABLE 1, the resin composition of Example 1 of the present invention showed good properties.

### Example 2

Example 2 was an example, in which a resin composition different from that of Example 1 was used. P-3500 and PTFE M-18 in the composition ratio (weight ratio) shown in TABLE 1 were fed to a twin screw extruder having a screw diameter of 20 mm in Example 2. Then, they were melt-kneaded in a condition where the temperature was 360° C. and the revolution was 60 rpm, turning them into pellets. Then, strip testing pieces were molded from the pellets. The molded pellets were heat treated in the thermal condition shown in TABLE 1. The heat treated strip testing pieces were subjected above-mentioned tests. Evaluation results were shown in TABLE 1.

As clearly shown in TABLE 1, the resin composition of Example 2 of the present invention showed good properties.

### Example 3

Example 3 was an example, in which a resin composition different from those of Examples 1 and 2 was used. PPSU R-5000 and PTFE M-18 in the composition ratio (weight ratio) shown in TABLE 1 were fed to a twin screw extruder having a screw diameter of 20 mm in Example 3. Then, they were melt-kneaded in a condition where the temperature was 360° C. and the revolution was 60 rpm, turning them into pellets. Then, strip testing pieces were molded from the pellets. The molded pellets were heat treated in the thermal condition shown in TABLE 1. The heat treated strip testing pieces were subjected above-mentioned tests. Evaluation results were shown in TABLE 1.

As clearly shown in TABLE 1, the resin composition of Example 3 of the present invention showed good properties.

### Example 4

Example 4 was an example, in which the shaped composition was held at 295° C. for 5 minutes. PES4800G and PTFE M-18 in the composition ratio (weight ratio) shown in TABLE 1 were fed to a twin screw extruder having a screw diameter of 20 mm in Example 3. Then, they were melt-kneaded in a condition where the temperature was 360° C. and the revolution was 60 rpm, turning them into pellets. Then, strip testing pieces were molded from the pellets. The molded pellets were heat treated in the thermal condition shown in TABLE 1. The heat treated strip testing pieces were subjected above-mentioned tests. Evaluation results were shown in TABLE 1.

As clearly shown in TABLE 1, the resin composition of Example 4 of the present invention showed good properties.

### Example 5

Example 5 is an example, in which the thermal condition was changed from Example 4. In Example 5, the shaped composition was held at 290° C. instead of 295° C. Evaluation results were shown in TABLE 1.

As clearly shown in TABLE 1, the resin composition of Example 5 of the present invention showed good properties.

### Example 6

Example 6 is an example, in which the thermal condition was changed from Example 4. In Example 6, the shaped composition was held at 300° C. instead of 295° C. Evaluation results were shown in TABLE 1.

As clearly shown in TABLE 1, the resin composition of Example 6 of the present invention showed good properties.

### Example 7

Example 7 is an example, in which the thermal condition was changed from Example 4. In Example 7, the shaped composition was held at 295° C. for 3 minutes, instead of 5 minutes. Evaluation results were shown in TABLE 1.

As clearly shown in TABLE 1, the resin composition of Example 7 of the present invention showed good properties.

It was demonstrated that the resin composition of Example 4 was particularly good in Examples 4, 5, 6, and 7, in terms of the heat deflection temperature, the abrasion amount, and the shape retention.

### Example 8

First, PES 4800G and PTFE M-18 in the composition ratio (weight ratio) shown in TABLE 1 were fed to a twin screw extruder having a screw diameter of 20 mm in Example 8. Then, they were melt-kneaded in a condition where the temperature was 360° C. and the revolution was 60 rpm, turning them into pellets. Then, strip testing pieces were molded from the pellets. The molded pellets were heat treated in the thermal condition shown in TABLE 1. The heat treated strip testing pieces were subjected above-mentioned tests. In Example 8, the heat treatment was performed in the mold. By performing the heat treatment in the mold, heat was exchanged between the shaped object and the mold made of metal, which has a higher heat conductivity than gas. As a result, it became possible to control the temperature of the shaped object more accurately. Consequently, deviation of thermal profiles in the material (for examples, the thermal profile on the surface of the shaped object and the thermal profile of the internal part of the shaped object) was reduced. In the end, the uniformity of the crystallinity of PTFE was improved. Evaluation results were shown in TABLE 1.

As clearly shown in TABLE 1, the resin composition of Example 8 of the present invention showed good properties.

### Example 9

Example 9 was different from Example 1 in the added amount of the PTFE particles. In example 9, 20 parts of PTFE particles by mass was added instead of 300 parts.

As clearly shown in TABLE 1, the resin composition of Example 9 of the present invention showed good properties. Evaluation results were shown in TABLE 1.

### Example 10

Example 10 was different from Example 1 in the added amount of the PTFE particles. In example 10, 900 parts of PTFE particles by mass was added instead of 300 parts. Evaluation results were shown in TABLE 1.

As clearly shown in TABLE 1, the resin composition of Example 10 of the present invention showed good properties.

### Example 11

Example 11 was different from Example 1 in the diameter of the PTFE particles. In example 11, the PTFE particles with a diameter of 400 μm were used. Evaluation results were shown in TABLE 1.

As clearly shown in TABLE 1, the resin composition of Example 11 of the present invention showed good properties. In terms of the moldability and the abrasion resistance, the resin composition of Example 1 was better than that of Example 11.

### Example 12

Example 12 was different from Examples 1 and 9 in the added amount of the PTFE particles. In example 12, 10 parts of PTFE particles by mass were added. Evaluation results were shown in TABLE 1.

As clearly shown in TABLE 1, the resin composition of Example 12 of the present invention was better than the compositions of Examples 1 and 9, in terms of the abrasion amount, moldability, and shape retention. However, the resin composition of Example 12 was inferior to the resin composition of Examples of 1 and 9, in terms of flexibility, since it had a higher hardness value.

### Example 13

The Example 13 was different from Examples 1 and 10 in the added amount of PTFE particles. In Example 13, 1000 parts PTFE particles by mass were added. Evaluation results were shown in TABLE 1.

As clearly shown in TABLE 1, the resin composition of Example 13 of the present invention was better than the compositions of Examples 1 and 10, in terms of flexibility, since it had a lower hardness value. However, the resin composition of Example 13 was inferior to the resin compositions of Examples 1 and 10, in terms of the abrasion amount, moldability, and shape retention.

### Comparative Example 1

Comparative Example 1 was an example, in which PFA AP-210 was used. The storage modulus of PFA AP-210 at 330° C. is less than 10 MPa. First, PFA AP-210 and PTFE M-18 in the composition ratio (weight ratio) shown in TABLE 2 were fed to a twin screw extruder having a screw diameter of 20 mm in Comparative Example 1. Then, they were melt-kneaded in a condition where the temperature was 360° C. and the revolution was 60 rpm, turning them into pellets. Then, strip testing pieces were molded from the pellets. The molded pellets were heat treated in the thermal condition shown in TABLE 2. The heat treated strip testing pieces were subjected above-mentioned tests. Evaluation results were shown in TABLE 2.

As clearly shown in TABLE 2, the resin composition of Comparative Example 1 was inferior to Example 1 of the present invention in terms of the heat deflection temperature and shape retention.

### Comparative Example 2

Comparative Example 2 was different from Example 1 of the present invention in using FEP NP-20 as a thermoplastic resin. The storage modulus of FEP NP-20 at 330° C. is less than 10 MPa. Evaluation results were shown in TABLE 2.

As clearly shown in TABLE 2, the resin composition of Comparative Example 2 was inferior to Example 1 of the present invention in terms of the heat deflection temperature and shape retention.

### Comparative Example 3

Comparative Example 3 was different from Example 1 of the present invention in the maximum heating temperature. The maximum heating temperature in Comparative Example 3 was 320° C. Evaluation results were shown in TABLE 2.

As clearly shown in TABLE 2, the resin composition of Comparative Example 3 was inferior to Example 1 of the present invention in terms of the heat deflection temperature and abrasion amount.

### Comparative Example 4

Comparative Example 4 was different from Example 1 of the present invention in the cooling speed in the thermal condition. The cooling speed in Comparative Example 4 was 15° C./min. Thus, the shaped object in Comparative Example 4 was cooled rapidly. Evaluation results were shown in TABLE 2.

As clearly shown in TABLE 2, the resin composition of Comparative Example 4 was inferior to Example 1 of the present invention in terms of the heat deflection temperature and abrasion amount.

### Comparative Example 5

Comparative Example 5 was different from Example 1 of the present invention in the cooling speed controlling temperature in the thermal condition. The cooling speed controlling temperature in Comparative Example 5 was 300° C. Thus, there was no temperature control below 300° C. in Comparative Example 5. Evaluation results were shown in TABLE 2.

As clearly shown in TABLE 2, the resin composition of Comparative Example 5 was inferior to Example 1 of the present invention in terms of the heat deflection temperature and abrasion amount.

Embodiments of the present invention were described above using Examples. However, specific configurations are not limited to the embodiments described above. Therefore, additions, omissions, substitutions, and other modifications can be made without departing from the scope of the present invention.

For example, the thermoplastic resin compound of the present invention may include one or more of components other than the thermoplastic resin and the PTFE particles as needed. The additional component(s) may be added to the mixture in any order. Alternatively, the additional component(s) may be added to the mixture simultaneously with the thermoplastic resin and the PTFE particles.

In addition, the heating step S3, which was described in the embodiments, may be performed in the kneading machine used in the melt-kneading step S2. Alternatively, the heat-processed product may be taken out from the kneading machine after the melt-kneading step S2 and arranged in the heating furnace in which the temperature inside is regulated as described above. Then, heating step S3 may be performed.

In addition, there is no specific limitation on the molding method of the mixture including the thermoplastic resin and the PTFE particles in the method of producing a thermoplastic resin composition of the present invention. For example, conventionally known methods, such as the extrusion molding, the injection molding, the compression molding, blow molding, and the like, may be used as the method of molding the thermoplastic resin. The heat treatment may be performed after the molding of the heat-processed product as needed. In that case, the heating step S3 may be performed by a method in which heated liquid is pored into the mold, a method in which the temperature is controlled by placing the mold into the heating furnace, or a method in which the temperature is controlled by arranging the shaped objects in the heating furnace.

The thermoplastic resin composition of the present invention can be utilized in the industrial use such as the medical field, the OA equipment parts field, the electronic/electronic device field, and the precision instruments field. In the medical field, the resin composition shaped into an O-ring, a forceps plug, a tube, a vessel, or the like, can be utilized. In addition, the thermoplastic resin composition of the present invention can be utilized in the auto parts field. However, the usage of the thermoplastic resin composition of the present invention is not limited to the fields mentioned above.

1. A method of producing a thermoplastic resin composition including a thermoplastic resin, a storage elastic modulus of which at 330° C. is 10 MPa or higher, and PTFE particles, which are added to the thermoplastic resin, comprising the steps of:
heating in which a heat-processed product is heated at a maximum heating temperature of 327° C. or higher, the heat-processed product being obtained by heat-processing a mixture containing the thermoplastic resin and the PTFE particles; and
cooling in which the heat-processed product is cooled at a cooling speed of 10° C./min or slower to 293° C. from the maximum heating temperature after the step of heating.

2. The method of producing the thermoplastic resin composition according to claim 1, wherein an elapsed time, which the heat-processed product is held in a temperature range of 293 to 297° C., is 5 minutes or longer.

3. The method of producing the thermoplastic resin composition according to claim 1, further comprising the step of heat-processing, in which the mixture is molded in a mold to obtain the heat-processed product, before the step of heating,
wherein the heat-processed product in the steps of heating and cooling is kept in the mold without taking out from the mold.

4. A thermoplastic resin composition comprising:
a thermoplastic resin, a storage elastic modules of which at 330° C. is 10 MPa or higher; and PTFE particles,
wherein a crystallinity of PTFE particles is 55 or higher.

5. The thermoplastic resin composition according to claim 4, wherein 20 to 900 parts of PTFE particles by weight are included in 100 parts of the thermoplastic resin with a storage elastic modulus of 10 MPa or higher at 330° C. by weight.

6. The thermoplastic resin composition according to claim 4, wherein an average diameter of the PTFE particles is 200 μm or less.

7. The method of producing the thermoplastic resin composition according to claim 2, further comprising the step of heat-processing, in which the mixture is molded in a mold to obtain the heat-processed product, before the step of heating,
wherein the heat-processed product in the steps of heating and cooling is kept in the mold without taking out from the mold.

8. The thermoplastic resin composition according to claim 5, wherein an average diameter of the PTFE particles is 200 μm or less.
